(19) United States
(12) Patent Application Publication
(10) Pub. No.: US 2020/0380530 A1
(43) Pub. Date: Dec. 3, 2020

(54) AUTOMATIC INTERNET OF THINGS ENABLED CONTRACT COMPLIANCE MONITORING

(71) Applicant: International Business Machines Corporation, Armonk, NY (US)

(72) Inventors: Craig M. Trim, Ventura, CA (US); Zachary A. Silverstein, Austin, TX (US); Martin G. Keen, Cary, NC (US); Robert Huntington Grant, Atlanta, GA (US)

(21) Appl. No.: 16/425,993

(22) Filed: May 30, 2019

(51) Int. Cl. G06Q 30/00; G06Q 50/18

(52) U.S. Cl. CPC G06Q 30/018; G06Q 50/18

(57) ABSTRACT

In an approach for automatically monitoring contract execution, a processor parses a contract into tangible and non-tangible contract elements using natural language processing techniques. A processor captures a data source associated with the tangible and non-tangible contract elements. A processor associates one or more Internet of Things (IoT) devices to the tangible and non-tangible contract elements based on the data source. A processor monitors the tangible and non-tangible contract elements for contract compliance using the one or more IoT devices. A processor determines non-compliance of an action monitored by the one or more IoT devices to the tangible and non-tangible contract elements. A processor, in response to determining the non-compliance of the action, notifies a user.

### BACKGROUND

The present disclosure relates generally to the field of contract compliance, and more particularly to automatic contract compliance monitoring.

A contract is a legally enforceable agreement to exchange value such as goods, services, or property. Contracts are a fundamental tool for coordinating economic activity. Contracts are made of numerous distinct clauses that establish basic information and contain the parties' rights and obligations. Legal contract execution needs to be monitored.

### SUMMARY

Aspects of an embodiment of the present disclosure disclose an approach for automatically monitoring contract execution. A processor parses a contract into tangible and non-tangible contract elements using natural language processing techniques. A processor captures a data source associated with the tangible and non-tangible contract elements. A processor associates one or more Internet of Things (IoT) devices to the tangible and non-tangible contract elements based on the data source. A processor monitors the tangible and non-tangible contract elements for contract compliance using the one or more IoT devices. A processor determines non-compliance of an action monitored by the one or more IoT devices to the tangible and non-tangible contract elements. A processor, in response to determining the non-compliance of the action, notifies a user.

### BRIEF DESCRIPTION OF THE DRAWINGS

FIG. 1 is a functional block diagram illustrating a contract compliance monitoring environment, in accordance with an embodiment of the present disclosure.

FIG. 2 is a flowchart depicting operational steps of a contract compliance monitoring program executing within the contract compliance monitoring environment of FIG. 1, in accordance with an embodiment of the present disclosure.

FIG. 3 is a diagram depicting operational steps of a contract compliance monitoring program executing within the contract compliance monitoring environment of FIG. 1, in accordance with an embodiment of the present disclosure.

FIG. 4 is a block diagram of components of a computing device of FIG. 1, in accordance with an embodiment of the present disclosure.

FIG. 5 depicts an embodiment of a cloud computing environment in accordance with the present disclosure.

FIG. 6 depicts an embodiment of abstraction model layers of a cloud computing environment, in accordance with the present disclosure.

### DETAILED DESCRIPTION

The present disclosure is directed to systems and methods for associating Internet of Things (IoT) devices to contractual terms and monitoring contract execution.

Legal contracts involve agreements and obligations between multiple parties. The presence of contracts ranging from micro contracts to larger massive corporate contracts can define a wide variety of situations. In the current state there is a demand for “smarter” contract processing. The present disclosure recognizes a solution that can take the analysis of a contract a step further, from an inactive processing tool to active context aware processing during contract execution. The present disclosure discloses an artificial intelligence processing of a smart contract, derivation of obligations and the associated real-world elements and IoT devices, and the contract's status through contract execution against obligations.

The present disclosure discloses automatically processing contracts using natural language classifying, natural language understanding, and natural language processing technologies. The present disclosure discloses pulling historical data about previous contracts and their associated data sources and comparing a current contract for similar data semantic categories and types. The present disclosure discloses searching for the web and outputs of each attached IoT device in the enterprise to find an IoT device to associate to the contractual clause. Once that clause is semantically associated to each output category, the data is monitored against a threshold determined by natural language processing of the clause, upon predicted violation or possible violation that the relevant parties will be notified.

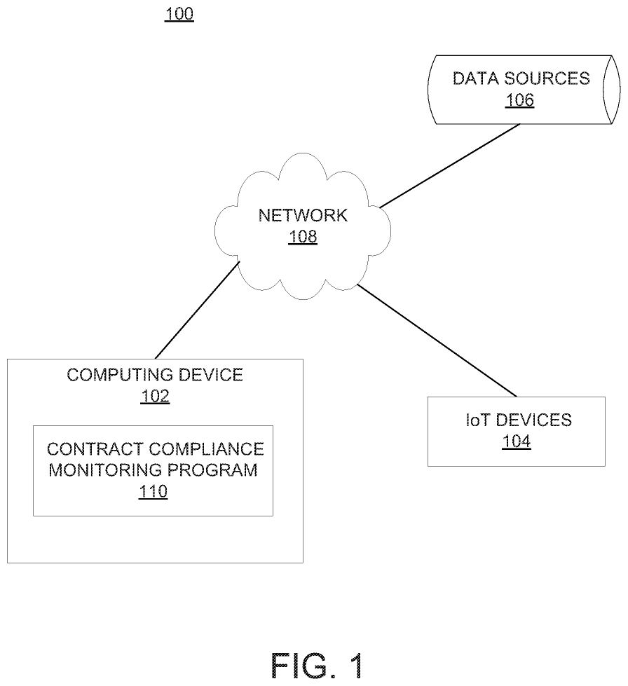

The present disclosure will now be described in detail with reference to the Figures. FIG. 1 is a functional block diagram illustrating a contract compliance monitoring environment, generally designated 100, in accordance with an embodiment of the present disclosure.

In the depicted embodiment, contract compliance monitoring environment 100 includes computing device 102, IoT devices 104, data sources 106, and network 108. In various embodiments of the present disclosure, the Internet of Things (IoT) is generally the extension of Internet connectivity into physical devices and objects. IoT devices 104 can be any object with embedded electronics that can transfer data over a network—with or without any human interaction. Examples are wearable devices, environmental sensors, machinery in factories, devices in homes and buildings, or components in a vehicle. Embedded with electronics, Internet connectivity, and other forms of hardware (such as sensors), IoT devices 104 can communicate and interact with others over the Internet. IoT devices 104 can be remotely monitored and controlled. Data sources 106 can be from IoT devices 104 on network. Data sources 106 can also be from historical data associations of a contract. Data sources 106 can also be from general interne web sites.

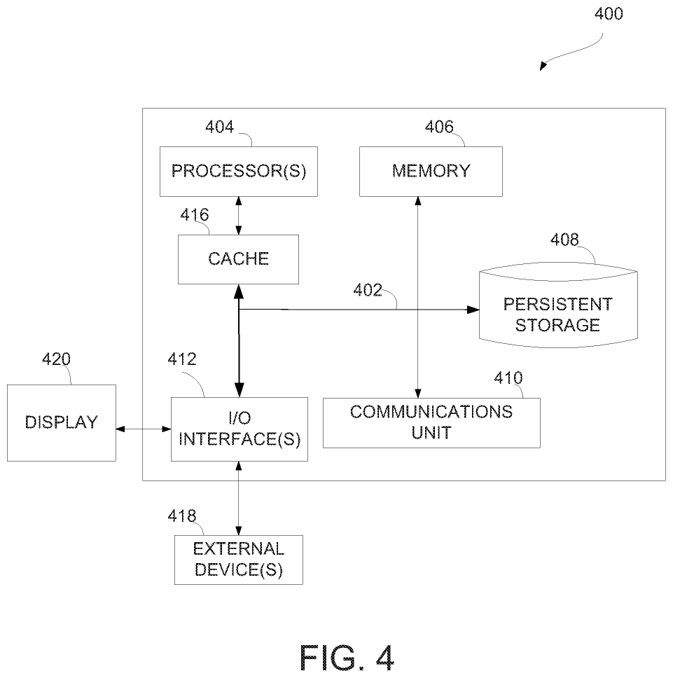

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to the contract compliance monitoring program 110 and the network 108 and is capable of processing program instructions and executing the contract compliance monitoring program 110, in accordance with an embodiment of the present disclosure. Computing device 102 may include internal and external hardware components, as depicted and described in further detail with respect to FIG. 4.

Further, in the depicted embodiment, computing device 102 includes contract compliance monitoring program 110. In the depicted embodiment, contract compliance monitoring program 110 is located on computing device 102. However, in other embodiments, contract compliance monitoring program 110 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and contract compliance monitoring program 110, in accordance with a desired embodiment of the disclosure.

In the depicted embodiment, contract compliance monitoring program 110 is configured to parse a contract into tangible and non-tangible contract elements using natural language processing techniques. A contract is an agreement with contractual terms between two or more parties in which there is a promise to do something in return for a consideration. A contractual term is any provision forming part of a contract. Each contractual term may give rise to a contractual obligation. A contract may be used for various transactions, including the sale of land or goods, or the provision of services. A breach of contract means that one or more parties has failed to perform a duty as set forth in the contract.

A natural language processing technique may include natural language classifying, natural language understanding, optical character recognition, and any other natural language processing techniques with analyzing, understanding, and generating natural human languages to interface with machines, for example, both in written and spoken forms.

A tangible contract element is a contract term that has some objective measurable tied to the contract. For example, a tangible contract element may be a number, date, time, place, or any other tangible components associated with the contract. On the other hand, a non-tangible contract element may be a contract term that requires a subjective viewpoint type analysis to evaluate. For example, a non-tangible contract element may be satisfaction, effort, expectation or any other non-tangible components associated with the contract. In an embodiment, each contract element is broken down into a codified approvable rule in a machine format. Codified obligations for each contract element are created in a method that is machine understandable. For tangible contract elements, contract compliance monitoring program 110 may directly codify the tangible contract elements based on the codified approvable rules. For non-tangible contract elements, contract compliance monitoring program 110 may create measurable obligations for the non-tangible contract elements based on mutually agreed upon parties using cognitive processing.

Contract compliance monitoring program 110 is configured to search and capture data sources 106 associated with the tangible and non-tangible contract elements. In an example, data sources 106 can be historical data associations of the contract. Contract compliance monitoring program 110 tracks the previous historical associated contracts and feeds those as recommendations and guidelines accordingly based on the tangible and non-tangible contract elements. In another example, contract compliance monitoring program 110 uses a web crawler to search internet web source and recommend IoT devices 104 to monitor the tangible and non-tangible contract elements of the contract. In yet another example, contract compliance monitoring program 110 searches IoT devices 104 on network 108 for associated properties and devices with the tangible and non-tangible contract elements. Contract compliance monitoring program 110 can search and capture any other data sources 106 that may be associated with the tangible and non-tangible contract elements of the contract.

Contract compliance monitoring program 110 is configured to associate Internet of Things (IoT) devices 104 selected from the associated data sources for monitoring the tangible and non-tangible contract elements of the contract. Selection of appropriate IoT devices 104 can be based on information from data sources 106 discussed above, including previous historical associated contracts, internet web source, and IoT devices 104 in network. In an example, selection of appropriate IoT devices 104 can be from IoT devices 104 exposed on a party's network, individual user devices, corporate managed devices, and associated beacons or other connected IoT devices 104.

Contract compliance monitoring program 110 is configured to monitor the tangible and non-tangible contract elements using the selected IoT devices 104. Contract compliance monitoring program 110 presents contractual obligations and IoT data sources for validation to associated parties of a contract. The associated parties agree on tracking metrics of the contract. In an example, each tangible and non-tangible contract element may be monitored by one or more IoT devices 104. In another example, each tangible and non-tangible contract element may be monitored by each respective IoT device 104. In another example, one or more tangible and non-tangible contract elements can be monitored by one IoT device 104. In another example, one or more tangible and non-tangible contract elements can be monitored by one or more IoT devices 104.

Contract compliance monitoring program 110 is configured to determine non-compliance of actions monitored by the one or more IoT devices 104 to the tangible and non-tangible contract elements. Contract compliance monitoring program 110 tracks obligations through the one or more IoT devices 104 and captures risk behaviors.

Contract compliance monitoring program 110 is configured, in response to determining the non-compliance of the actions monitored by the one or more IoT devices 104 to the tangible and non-tangible contract elements, to notify a user. The user may be one or more of the parties involved with the contract. For example, contract compliance monitoring program 110 may send a text message to alert the user. Contract compliance monitoring program 110 may notify a user by other communication methods such as, for example, by sending an email or a voice message. Contract compliance monitoring program 110 may capture failure scenarios and associated documentation for ease of resolution. Parties are provided contractual violation information with data sources for escalated speed in resolution and agreement between parties.

Contract compliance monitoring program 110 is configured to determine availability of an alternative IoT device to manage a service level agreement relative to the tangible and non-tangible contract elements. Contract compliance monitoring program 110 tracks the data across the various IoT devices 104 and determines any statistical relationship that might fulfill the IoT device obligation not detected through a natural language processing technique. Contract compliance monitoring program 110 may provide feedback for future contracts where ideal IoT devices may not be available or non-functional. Contract compliance monitoring program 110 is configured to associate data captured by IoT devices 104 with contract terms and determining whether there is any violation to the contract based on contract terms and IoT feed.

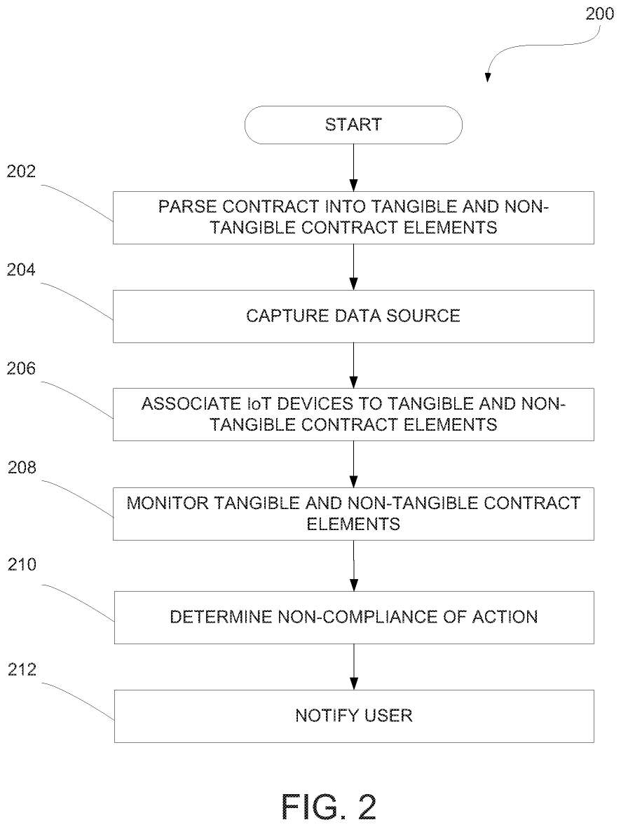

FIG. 2 is a flowchart 200 depicting operational steps of contract compliance monitoring program 110 in accordance with an embodiment of the present disclosure.

Contract compliance monitoring program 110 operates to parse contractual terms into tangible and non-tangible contract elements using natural language processing techniques. Contract compliance monitoring program 110 also operates to capture a data source associated with the tangible and non-tangible contract elements. Contract compliance monitoring program 110 operates to identify one or more IoT devices from the data source and monitor the tangible and non-tangible contract elements using the one or more IoT devices. Contract compliance monitoring program 110 operates to determine non-compliance of actions monitored by the one or more IoT devices to the tangible and non-tangible contract elements and, in response to determining non-compliance of the actions, notifies a user.

In step 202 contract compliance monitoring program 110 parses a contract into tangible and non-tangible contract elements using natural language processing techniques. For example, a natural language processing technique may include natural language classifying, natural language understanding, optical character recognition, and any other natural language processing techniques with analyzing, understanding, and generating natural human languages to interface with machines, for example, both in written and spoken forms.

A tangible contract element is a contract term that has some objective measurable tied to the contract. For example, a tangible contract element may be a number, date, time, place, or any other tangible components associated with the contract. On the other hand, a non-tangible contract element may be a contract term that requires a subjective viewpoint type analysis to evaluate. For example, a non-tangible contract element may be satisfaction, effort, expectation or any other non-tangible components associated with the contract. In an embodiment, each contract element is broken down into a codified approvable rule in a machine format. Codified obligations for each contract element are created in a method that is machine understandable. For tangible contract elements, contract compliance monitoring program 110 may directly codify the tangible contract elements based on the codified approvable rules. For non-tangible contract elements, contract compliance monitoring program 110 may create measurable obligations for the non-tangible contract elements based on mutually agreed upon parties using a cognitive processing.

In step 204 contract compliance monitoring program 110 searches and captures data sources 106 associated with the tangible and non-tangible contract elements. Tangible and non-tangible contract elements are fed into contract compliance monitoring program 110 to process related data sources 106 and IoT devices 104. In an example, data sources 106 can be historical data associations of the contract. Contract compliance monitoring program 110 tracks the previous historical associated contracts and feeds those as recommendations and guidelines accordingly based on the tangible and non-tangible contract elements. In another example, contract compliance monitoring program 110 uses a web crawler to search internet web source and recommend IoT devices 104 to monitor the tangible and non-tangible contract elements of the contract. In yet another example, contract compliance monitoring program 110 searches IoT devices 104 on network 108 for associated properties and devices with the tangible and non-tangible contract elements of the contract. Contract compliance monitoring program 110 can search and capture any other data sources 106 that may be associated with the tangible and non-tangible contract elements of the contract.

In step 206 contract compliance monitoring program 110 associates IoT devices 104 selected from the associated data sources for monitoring the tangible and non-tangible contract elements of the contract. Selection of appropriate IoT devices 104 can be based on information from data sources 106 discussed above, including previous historical associated contracts, internet web source, and IoT devices 104 in network 108. In an example, selection of appropriate IoT devices 104 can be from IoT devices 104 exposed on a party's network, individual user devices, corporate managed devices, and associated beacons or other connected IoT devices 104.

In step 208 contract compliance monitoring program 110 monitors the tangible and non-tangible contract elements using the selected IoT devices 104. Contract compliance monitoring program 110 presents contractual obligations and IoT data sources for validation to associated parties of a contract. The associated parties agree on tracking metrics of the contract. In an example, each tangible and non-tangible contract element may be monitored by one or more IoT devices 104. In another example, each tangible and non-tangible contract element may be monitored by each respective IoT device 104. In another example, one or more tangible and non-tangible contract elements can be monitored by one IoT device 104. In another example, one or more tangible and non-tangible contract elements can be monitored by one or more IoT devices 104.

In step 210 contract compliance monitoring program 110 determines non-compliance of actions monitored by the one or more IoT devices 104 to the tangible and non-tangible contract elements. Contract compliance monitoring program 110 tracks obligations through the one or more IoT devices 104 and captures risk behaviors.

In step 212 contract compliance monitoring program 110, in response to determining non-compliance of actions to the tangible and non-tangible contract elements, notifies a user. The user can be a relevant party of the contract. In an example, contract compliance monitoring program 110 may send a text message to alert the user. Contract compliance monitoring program 110 may notify a user by other communication methods such as, for example, by sending an email or a voice message. Contract compliance monitoring program 110 may capture failure scenarios and associated documentation for ease of resolution. Parties are provided contractual violation information with data sources for escalated speed in resolution and agreement between parties.

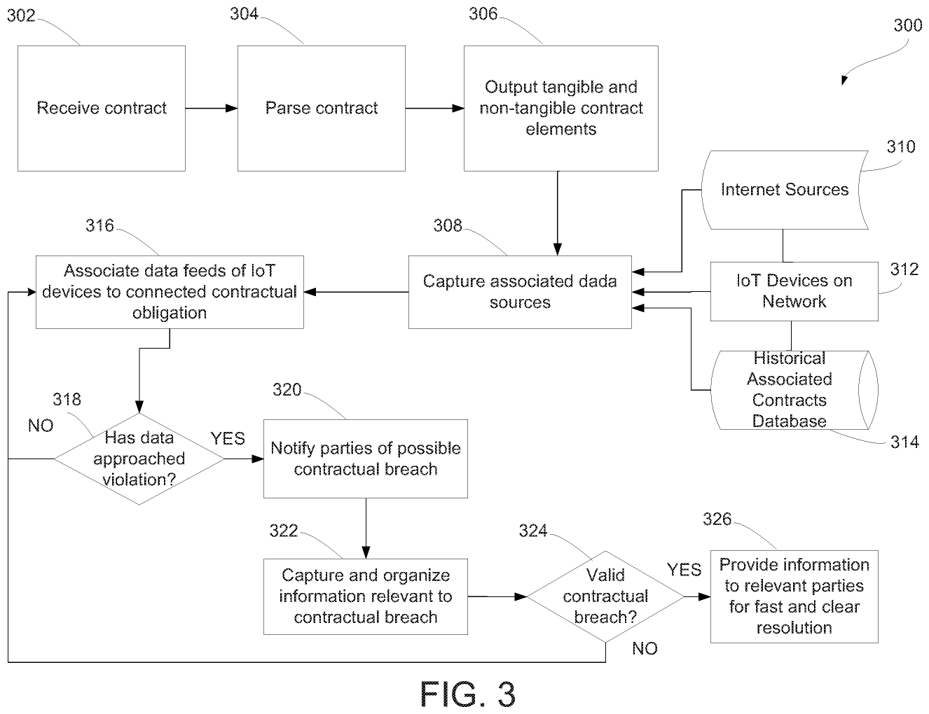

FIG. 3 is a diagram 300 depicting operational steps of contract compliance monitoring program 110 in accordance with an embodiment of the present disclosure.

When a contract is written up between multiple parties, the contract may involve multiple contractual terms and obligations. The parties would need to agree to a smart contract processing using contract compliance monitoring program 110. Contract compliance monitoring program 110 parses the contract and outputs contractual terms, including, for example, contract information, obligations, party requirements, key people association, key and entity association. Contract compliance monitoring program 110 captures associated data sources from, for example, interne sources, IoT devices and historical associated contracts. An automated processing engine monitors these metrics live while the contract terms are in effect. Based on an impending violation, the relevant parties are notified accordingly. Audit logs may be built for future validation against the contract terms.

In step 302 contract compliance monitoring program 110 receives a contract which is signed between parties who agree to a smart contract processing using the contract compliance monitoring program 110. A contract is an agreement with contractual terms between two or more parties in which there is a promise to do something in return for a valuable benefit known as consideration. A contractual term is any provision forming part of a contract. Each term gives rise to a contractual obligation, breach of which can give rise to litigation. A breach of contract means that one or both parties has failed to perform their duty.

In step 304 contract compliance monitoring program 110 parses the contract into tangible and non-tangible contract elements using natural language processing techniques. In step 306 contract compliance monitoring program 110 outputs the contract with tangible and non-tangible contract elements including, for example, obligations, party requirements, key people association, key entity association and any other contract information. A natural language processing technique may include natural language classifying, natural language understanding, optical character recognition, and any other natural language processing technique.

In step 308 contract compliance monitoring program 110 captures associated data sources 106 from internet sources 310, IoT devices 312 on network and historical associated contracts database 314. In one example, contract compliance monitoring program 110 tracks historical associated contracts database 314 and feeds those as recommendations and guidelines accordingly. In another example, contract compliance monitoring program 110 uses a web crawler to parse internet sources 310, for example, a website, for recommendation of IoT devices to monitor the tangible and non-tangible contract elements of the contract. In yet another example, contract compliance monitoring program 110 searches IoT devices 312 on network for properties and devices associated with the tangible and non-tangible contract elements of the contract.

In step 316 contract compliance monitoring program 110 associates data feeds of the selected IoT devices based on the data sources associated with the connected tangible and non-tangible contract elements of the contract including contractual obligations. Selection of appropriate IoT devices can be based on information from the associated data sources of internet sources 310, IoT devices 312 on network 108 (see FIG. 1) and historical associated contracts database 314. In an example, selection of appropriate IoT devices can be from IoT devices 312 exposed on a party's network, individual user devices, corporate managed devices, and associated beacons or other IoT connected devices.

In decision 318 contract compliance monitoring program 110 determines whether any associated data has approached a violation of a contractual term. For example, contract compliance monitoring program 110 analyzes data received from the IoT devices monitoring the tangible and non-tangible contract elements of the contract and determines whether the data has approached to a violation of a contractual obligation based on a pre-determined threshold. If there is an approaching violation (decision 318, “YES” branch), contract compliance monitoring program 110 notifies parties of possible contractual breach in step 320. If there is not an approaching violation (decision 318, “NO” branch), contract compliance monitoring program 110 continues to monitor associated data feeds through the associated IoT devices. In step 322 contract compliance monitoring program 110 captures and organizes information relevant to the possible contractual breach.

In decision 324 contract compliance monitoring program 110 determines whether the possible contractual breach is valid based on the relevant information captured. If contract compliance monitoring program 110 determines there is a valid contractual breach (decision 324, “YES” branch), in step 326 contract compliance monitoring program 110 provides information to relevant parties for fast and clear resolution. If there is not a valid contractual breach (decision 324, “NO” branch), contract compliance monitoring program 110 continues to monitor associated data feeds through the associated IoT devices.

FIG. 4 depicts a block diagram 400 of components of computing device 102 in accordance with an illustrative embodiment of the present disclosure. It should be appreciated that FIG. 4 provides only an illustration of one implementation and does not imply any limitations with regard to the environments in which different embodiments may be implemented. Many modifications to the depicted environment may be made.

Computing device 102 may include communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Contract compliance monitoring program 110 may be stored in persistent storage 408 and in memory 406 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Contract compliance monitoring program 110 may be downloaded to persistent storage 408 through communications unit 410.

I/O interface(s) 412 allows for input and output of data with other devices that may be connected to computing device 102. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., contract compliance monitoring program 110 can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

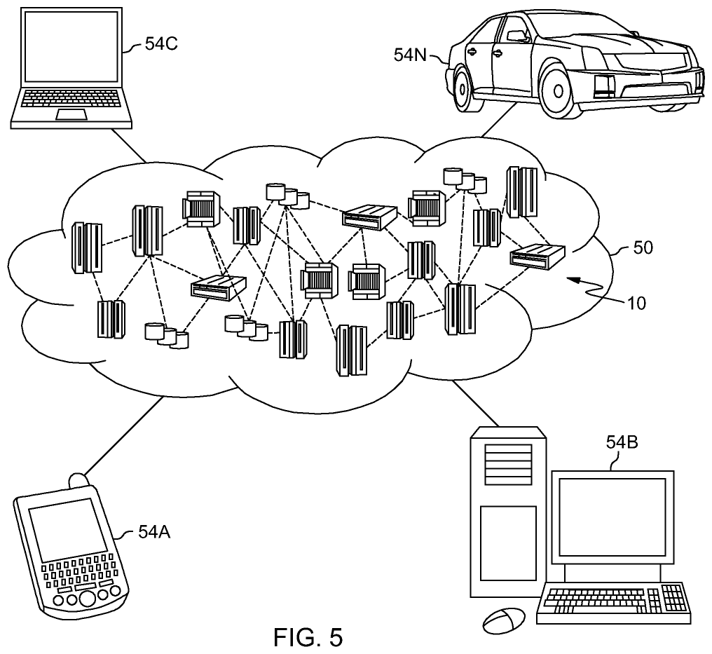

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

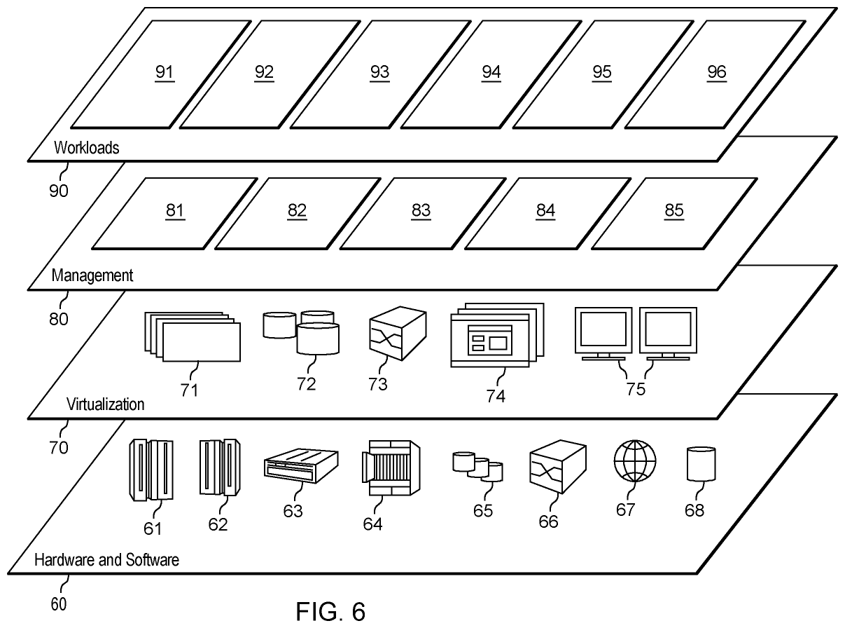

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and module 96 including, for example, contract compliance monitoring program 110 as described above with respect to contract compliance monitoring environment 100.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
parsing, by one or more processors, a contract into tangible and non-tangible contract elements using natural language processing techniques;
capturing, by one or more processors, a data source associated with the tangible and non-tangible contract elements;
associating, by one or more processors, one or more Internet of Things (IoT) devices to the tangible and non-tangible contract elements based on the data source;
monitoring, by one or more processors, the tangible and non-tangible contract elements for contract compliance using the one or more IoT devices;
determining, by one or more processors, non-compliance of an action monitored by the one or more IoT devices to the tangible and non-tangible contract elements; and
in response to determining the non-compliance of the action, notifying, by one or more processors, a user.

2. The computer-implemented method of claim 1, further comprising:
determining, by one or more processors, availability of an alternative IoT device to manage the contract relative to the tangible and non-tangible contract elements.

3. The computer-implemented method of claim 1, further comprising:
associating, by one or more processors, data captured by the one or more IoT devices with the tangible and non-tangible contract elements and determining, by one or more processors, whether there is violation to the contract based on the tangible and non-tangible contract elements and the one or more IoT devices.

4. The computer-implemented method of claim 1, wherein the tangible and non-tangible contract elements include contractual terms for obligations for each party of the contract.

5. The computer-implemented method of claim 1, wherein the one or more IoT devices are identified from an IoT network associated with the contract.

6. The computer-implemented method of claim 1, wherein the one or more IoT devices are identified based on information from a historical contract database associated with the contract.

7. The computer-implemented method of claim 1, wherein the one or more IoT devices are identified based on information from an internet source associated with the tangible and non-tangible contract elements.

8. A computer program product for automatically monitoring contract execution, the computer program product comprising:
one or more computer readable storage media and program instructions stored on the one or more computer readable storage media, the program instructions comprising:
program instructions to parse a contract into tangible and non-tangible contract elements using natural language processing techniques;
program instructions to capture a data source associated with the tangible and non-tangible contract elements;
program instructions to associate one or more Internet of Things (IoT) devices to the tangible and non-tangible contract elements based on the data source;
program instructions to monitor the tangible and non-tangible contract elements for contract compliance using the one or more IoT devices;
program instructions to determine non-compliance of an action monitored by the one or more IoT devices to the tangible and non-tangible contract elements; and
program instructions to, in response to determining the non-compliance of the action, notify a user.

9. The computer program product of claim 8, further comprising:
program instructions, stored on the one or more computer-readable storage media, to determine availability of an alternative IoT device to manage the contract relative to the tangible and non-tangible contract elements.

10. The computer program product of claim 8, further comprising:
program instructions, stored on the one or more computer-readable storage media, to associate data captured by the one or more IoT devices with the tangible and non-tangible contract elements and to determine whether there is violation to the contract based on the tangible and non-tangible contract elements and the one or more IoT devices.

11. The computer program product of claim 8, wherein the tangible and non-tangible contract elements include contractual terms for obligations for each party of the contract.

12. The computer program product of claim 8, wherein the one or more IoT devices are identified from an IoT network associated with the contract.

13. The computer program product of claim 8, wherein the one or more IoT devices are identified based on information from a historical contract database associated with the contract.

14. The computer program product of claim 8, wherein the one or more IoT devices are identified based on information from an interne source associated with the tangible and non-tangible contract elements.

15. A computer system for automatically monitoring contract execution, the computer system comprising:
one or more computer processors, one or more computer readable storage media, and program instructions stored on the one or more computer readable storage media for execution by at least one of the one or more computer processors, the program instructions comprising:
program instructions to parse a contract into tangible and non-tangible contract elements using natural language processing techniques;
program instructions to capture a data source associated with the tangible and non-tangible contract elements;
program instructions to associate one or more Internet of Things (IoT) devices to the tangible and non-tangible contract elements based on the data source;
program instructions to monitor the tangible and non-tangible contract elements for contract compliance using the one or more IoT devices;
program instructions to determine non-compliance of an action monitored by the one or more IoT devices to the tangible and non-tangible contract elements; and
program instructions to, in response to determining the non-compliance of the action, notify a user.

16. The computer system of claim 15, further comprising:
program instructions, stored on the one or more computer-readable storage media, to determine availability of an alternative IoT device to manage the contract relative to the tangible and non-tangible contract elements.

17. The computer system of claim 15, further comprising:
program instructions, stored on the one or more computer-readable storage media, to associate data captured by the one or more IoT devices with the tangible and non-tangible contract elements and to determine whether there are violations to the contract based on the tangible and non-tangible contract elements and the one or more IoT devices.

18. The computer system of claim 15, wherein the tangible and non-tangible contract elements include contractual terms for obligations for each party of the contract.

19. The computer system of claim 15, wherein the one or more IoT devices are identified from an IoT network associated with the contract.

20. The computer system of claim 15, wherein the one or more IoT devices are identified based on information from a historical contract database associated with the contract.
